(19) United States
(12) Patent Application Publication
(10) Pub. No.: US 2007/0203888 A1
(43) Pub. Date: Aug. 30, 2007

(54) Simple hierarchical Web search engine

(76) Inventors: Cun Wang, Cerritos, CA (US); Yaliang Wang, Cerritos, CA (US)

Correspondence Address: Xiaoling Guo, 18528 Casandra Avenue, Cerritos, CA, 90703, US

(21) Appl. No.: 11/359,906

(22) Filed: Feb. 24, 2006

(51) Int. Cl. G06F 17/30

(52) U.S. Cl. 707/3

(57) ABSTRACT

This specification discloses a unique Web search engine to help people find information on the Web more easily and efficiently, and a page-sized query algorithm which is applicable to Web search engines and other systems using large-scale databases. The Web search engine utilizes a simple hierarchical structure under the category Web, multiple ranks of records, diversified views of search results, display of unlimited records that are matched with keywords in the database, and opening any page of search results randomly. The page-sized query is different from the conventional queries in which the records are displayed on pages by skipping from the beginning of the record set (except page 1). In the page-sized queries, the records are directly displayed from the beginning of the record set on all pages, and the query size is restricted to a proper number that is equal to or a little larger than the record number for one page.

### BACKGROUND OF THE INVENTION

The present invention relates to methods and systems to help people more easily and efficiently search information on the Web. More particularly, the invention mainly focuses on a unique Web search engine and a page-sized query algorithm. With the Web search engine people can easily perform search, simply filter out some irrelevant documents, more completely browse search results, and efficiently find needed information in the large number of Web resources. By using the page-sized query algorithm, more robust Web search engines and other systems using large-scale databases can be built.

The Web has brought together a large number of information resources, information providers and users. How to make this kind of large-scale information exchange easy and efficient is a challenging issue. Based on existing information retrieval and database technologies, the Web search engines and directories have been fast developed to help people search information over the Internet. The popular services include Yahoo, Google, AltaVista, WebCrowler, NorthernLight, Excite, Lycos, AOL and Ask Jeeves, etc.

In the prior art, the great efforts have been made on search result ranking, keyword refinement and document classification. Since automated search engines that rely on keyword matching usually return many irrelevant records, the result ranking algorithms were created to improve the chance that relevant search results appear first in the search response. The purpose is to make general Web users to be as satisfied as possible by only viewing the first few tens of records. A typical example is Google search engine, which applies the analysis of scientific literature citation to the Web documents and uses a feature called PageRank to prioritize the results of Web keyword searches. Because selection of keywords is important to what results are retrieved from the database, the modules of keyword refinement have also been implemented in some search engines including AOL and Ask Jeeves.

The classification is a conventional and effective method to handle the large number of documents, and has been used in many search engines. Google mainly puts all Web resources in the category Web, Images, Groups, News, Froogle and Local. Lycos uses the category Web, People, YellowPages, Shopping, Images & Audio, News. AOL uses the category Web, Pictures, Video, Audio, News, Local and Shopping. Ask Jeeves uses the category Web, Pictures, News, Local and Products. Search directories are hierarchical databases with references to websites, in which information is classified according to some rules. Yahoo directory is one of this kind of services. It covers popular topics, builds hierarchical categories for selected and classified Web documents. Ask Jeeves also uses the search directory to organize product information.

Based on the prior work, the present invention intends to create a more effective and completed tool to help people search information on the Web. The addressed issues include a simple hierarchical structure, a page-sized query algorithm, multiple ranks and diversified views of search results, display of unlimited records that are matched with keywords in the database, and randomly opening any page of search results.

### BRIEF SUMMARY OF THE INVENTION

It is an object of the present invention to develop methods and systems to help people more easily and efficiently find needed information from the very large number of resources on the Web. Based on existing Web search technologies, the present invention made some unique improvements on document classification, database query, search result ranks, record sorting and data visualization, etc. With these improvements, people can simply filter out some irrelevant Web documents and more completely browse search results.

First, the present invention creates a simple hierarchical structure to narrow down the search scope under the category Web. In this structure, the top node is Web; the Web has sub node Resource, Product and Service; the Resource has sub node General and Music; the Product has sub node Large Business and Small Business; and the Service has sub node Anywhere and Local. In addition, the Resource has the property Download, the Product has the property Shopping, the Service has the property Reservation, and the Local has the property Location. With this structure, the search can be narrowed down to a comparatively smaller scope to reduce the irrelevant rate. Because the structure is very simple, it is possible to be automated and is easy to be accepted by most of users.

Second, the present invention creates a systematic page-sized query algorithm. Different from the conventional queries in which the records are displayed on pages by skipping from the beginning of the record set (except page 1), in the page-sized queries, the records are directly displayed from the beginning of the record set on all pages, and the query size is restricted to a proper number that is equal to or a little larger than the record number for one page. That is, when showing records on a specific page, no redundant records for other pages are listed in the beginning of the record set, and all or most of records in the result set are shown on this page.

Based on the page-sized query algorithm, the present invention uses multiple ranks and diversified views instead of single rank and view to display search results. The primary view is still the rank which is determined by the relevance calculated through statistical methods. Besides this, the present invention allows subscribed managers and professional editors to manage records on the different levels and then builds a human-managed rank. The purpose of this rank is not to replace the primary rank, but to increase the chance that some potential high-relevant records listed in the medium or last part of the primary rank have chance to be viewed by users. The conventional database sorting technology is also applied to the Web search engine, and the search results are sorted by title, domain name and date. The diversified views also include viewing contents of pages by tool tips. In addition, due to use of page-sized query algorithm, unlimited records that are matched with keywords in the database can be displayed. Any page can be randomly opened by giving a page number. To help users select a page number, the system creates a random number called “Lucky Number”.

It is an advantage of the present invention to use the simple hierarchical structure to narrow down the search scope under the category Web. The Web is a very broad category and most of Web searches are done in it. To narrow down its search scope, more detailed classification like the search directory may be ideal, but it is subjective, expensive and slow to improve. Also some users who like the simplicity of the search engine are not willing to use detailed hierarchical structure to search information. The simple hierarchical structure of the present invention is possible to be automatically implemented in the search engine, is easy to be accepted by most of users, and can reduce irrelevant rate of keyword matching to some degree.

It is an advantage of the present invention to use various ways to encourage users to view more records after they view the first few tens of records to achieve their personal search goals. If only providing a single view, it is true that people are only willing to look at the first tens of records. Because the ranking algorithms for these records are usually based on abstract criteria (such as Web page popularity), the users' personal search goals are often neglected. However, if there are multiple ranks and diversified views, people may still continue to have great interests in what I can find in another rank, what I can find on a random page, and what I can find in the order of date, etc., and then increase the chance that users can find information that they exactly need.

It is an advantage of the present invention to display unlimited records as needed and open any page randomly by inputting a page number. It is possible that the information needed by an individual user is on the pages with the very large page numbers. As a user-friendly search tool, it is necessary to display these pages when a user wants to view them. The present invention made this possible, and all search results can be displayed no matter how many records are matched with keywords in the database. Also users can randomly open some pages to view after they finish reading the first few tens of records.

It is an advantage of the present invention to use small size of queries instead of large size of queries to display pages, especially ones with the larger page numbers. In the practice, the queries that return a large set of records sometimes cause the problems of database systems, such as database hung or crash. In the present invention, the page-sized query only returns a small set of records that is enough to display one page, and then greatly reduces the system problems and makes systems more robust. Of course, in the page-sized queries some additional computing, such as getting minimum or maximum value, is necessary, but this is not a problem in the current high-speed computing environment.

### BRIEF DESCRIPTION OF THE DRAWINGS

For a more complete understanding of the invention, reference is made to the following Detailed Description of the Invention, and accompanying drawing, in which

FIG. 1 shows a simple hierarchical structure which is used to narrow down the search scope under the category Web in Web search engines.

FIG. 2 illustrates the basic principle of the page-sized query algorithm. In the page-sized queries the records are displayed from the beginning of the record set on all pages and the query size is equal to or a little larger than the record number for one page.

### DETAILED DESCRIPTION OF THE INVENTION

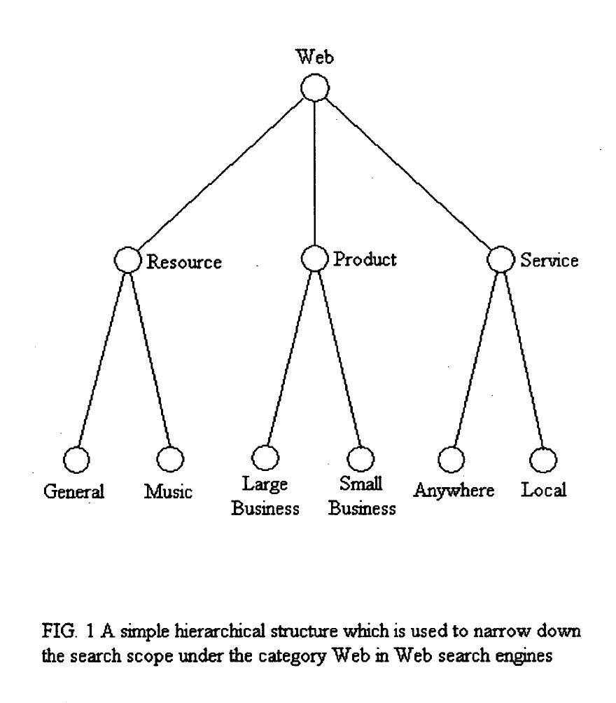

As shown in FIG. 1, the present invention creates a simple hierarchical structure to narrow down the scope of searches that rely on keyword matching in the Web search engine. The top node is Web. Under the top node, there are three sub nodes: Resource, Product and Service. Furthermore, the node Resource has sub node General and Music, the node Product has sub node Large Business and Small Business, and the node Service has sub node Anywhere and Local. In addition, the Resource has the property Download, the Product has the property Shopping, the Service has the property Reservation, and the Local has the property Location, etc.

The simple hierarchical structure is derived from looking into the problems of search engines. The main problem of search engines is not that they find too little, but that they find too much. Therefore, it is necessary to narrow down the search scope, but the structure must be simple and meet users' needs. The present invention simply defines several hierarchical nodes in the structure based on the analysis of users' needs. To seek information, any user goes on the Internet to do nothing but find resources, products or services. If taking look at different users' interests, a student may be interested in music and then download music, a young person may go on the Web just for amusing his/her self and then view general pages or hot topics, and a resident may try to find services near his/her home and then search local services in an area.

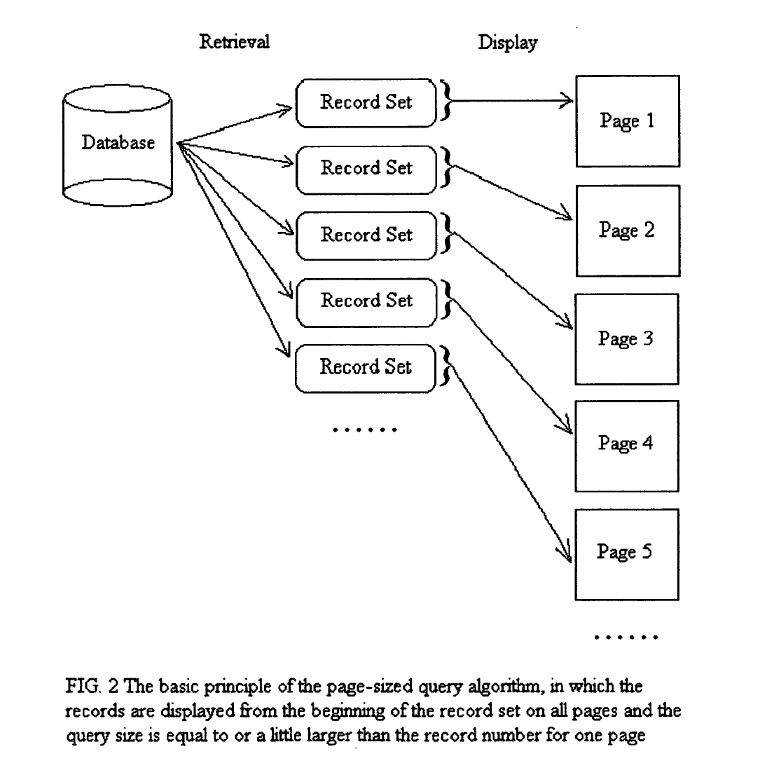

The page-sized query algorithm is one of major features of the present invention. Conventionally, the queries return all or the first part of records that are matched with the query criteria and are allowed by the system capability. When showing search results on pages, only for page 1, the records are displayed from the beginning of the record set, and for all other pages, the records must be skipped from the beginning of the record set to get records for a specific page in the query results. However, in the page-sized queries, the records are displayed from the beginning of the record set on all pages and the query size is restricted to a proper number that is equal to or a little larger than the record number for one page. That is, the records for each page are dynamically retrieved from the database without ones that should be skipped from the beginning of the record set, and the query size for all pages is very small. For example, if 20 records are shown on each page and the current page number is 5, only records from the 81^{st} to the 100^{th} or a little more are retrieved from the database. FIG. 2 illustrates the basic principle of the page-sized query algorithm.

The major issue of the page-sized query algorithm is to determine a value X based on which the records are retrieved from the database. If expressed in the Structure Query Language (SQL), it is an additional value in WHERE clause with the operator “>”, “>=”, “<”, “<=”, “LIKE” or “BETWEEN . . . AND . . . ” besides the actual query criteria. The following is an example in MSSQL:

SELECT TOP 20*FROM Item WHERE rankNumber>“X” AND keyword=“Search Engine” ORDER BY rankNumber.

The value X is different for initial page, next page and previous page, and the operator is different in ascending and descending order. In the ascending order, the value for the initial page is the minimum value, and the operator is “>=”; the value for the next page is the value of the last record on the current page, and the operator is “>”; the value for the previous page is the value of the first record on the current page, and the operator is “<”. In the descending order, the value for the initial page is the maximum value, and the operator is “<=”; the value for the next page is the value of the last record on the current page, and the operator is “<”; the value for the previous page is the value of the first record on the current page, and the operator is “>”. The initial page, next page and previous page include the single page and the page array. If records for multiple pages are retrieved together from the database, a page array is created to keep the values for each page. The value X in the different situations is shown in the table below:

TABLE I

| | Ascending Order | Descending Order |
|---|---|---|
| Initial Page | >=Minimum value | <=Maximum value |
| Next Page | >The value of the last | <The value of the last |
| | record on the current page | record on the current page |
| Previous Page | <The value of the first | >The value of the first |
| | record on the current page | record on the current page |

In the table above, the operator “>” and “<” can be converted to “>=”, “<=” or “LIKE” as needed by modifying the given value properly. For example, if the original expression is “>300”, then it can be converted to “>=300.0000000001” as long as all value differences of the data field are larger than 0.0000000001. If the original expression is “>‘xyz’”, then it can be converted to “(LIKE ‘xyz %’ AND NOT LIKE ‘xyz’) OR LIKE ‘y %’ OR LIKE ‘z %’”. In the page-sized queries, this kind of conversion is sometimes necessary. Also some common database functions such as min( ) and max( ) are useful for the implementation of the page-sized queries.

In the situation that the database field used for record ranking contains duplicate data set, the value X should be determined by the data in the ranking field plus the primary key. TABLE II shows an example of sorting records by the domain name which contains duplicate data set.

TABLE II

| ID | URL | DomainName |
|---|---|---|
| . . . | . . . | . . . |
| 79 | http:/www.abc.com/home.html | abc.com |
| 80 | http://www.this.com/index.html | this.com |
| 81 | http://www.this.com/welcome.html | this.com |
| 82 | http://www.this.com/about.html | this.com |
| 83 | http://www.xyz.com/home.html | xyz.com |
| . . . | . . . | . . . |

If page 5 starts from the 81^{st} record, then the value X for the page-sized query is “this.com” in the field of DomainName. To avoid the 80^{th} record that should be shown on another page being retrieved, the value X in this situation should be plus the data in the field ID, which is the primary key. The SQL statement (in MSSQL) of the page-sized query for page 5 is as follows:

SELECT TOP 20*FROM Item WHERE DomainName>=“this.com” AND ID>80 ORDER BY DomainName.

Based on the page-sized query, the present invention uses multiple ranks instead of conventional single rank. One is the rank by statistics, including counting keyword occurrences, matching keywords in title, meta tags, anchor text and the contents, and referring to user hits, etc. to estimate the relevance for pages. Another is the rank by human management. The records are managed on the different levels by subscribed mangers and professional editors. To make the field data to be able to record the information about the relevance or the human-managed level without duplicate, the present invention defines the data type of these fields as CHAR but limits use of characters to [0-9] and ‘.’. All data in these fields are same in length and are divided into two parts: the first part is used to record ranking information, and the second part is same as the primary key.

Sorting with different fields is a conventional method of general database systems to give users diversified views of records. This feature has not been implemented in existing Web search engines. The present invention applies this feature to the fields of title, domain name and date of Web pages by using the page-sized query. The reason is that sorting with title, domain name and date does not affect the view of the primary rank which intends to show high-relevant records first, but can help users to find more information that meets their personal needs. After searching with keywords, users usually view records by the primary rank, which is shown first. If unsatisfied with the primary rank, they then try to change to the different views to see if some needed information can be found.

Display of unlimited records is the nature of the page-sized query. Since the query size in the page-sized queries is restricted to a proper number that is equal to or a little larger than the record number for one page, any record can be displayed no matter how large the database is and how many records are matched with keywords in the database. The algorithm to open a page randomly is to utilize the page array of the page-sized query. The given page number is matched with the page number in the page array. If matched, the value X is returned to perform the page-sized query. Otherwise, the page array is filled with another set of data to continue matching. Also to help user select a page number, the system creates and displays a random number called “Lucky Number”.

The present invention particularly focuses on methods and systems to help people find information on the Web more easily and efficiently, and achieve their personal search goals. Based on the prior work of Web search engines, the present invention made efforts on document classification, database query, search result ranks, record sorting and data visualization, etc. The advantages of the present invention include learning the strengths of both Web search engine and directory, creating the simple hierarchical structure under the category Web to narrow down its search scope, using various ways to encourage users to view more records after they view the first few tens of records, displaying unlimited records that are matched with keywords in the database, opening any page randomly by inputting a page number, and using small size of queries instead of large size of queries to display pages.

It will be appreciated that although the invention is described with respect to several features and embodiments, the scope of the invention is to be limited only by the scope of the claims and equivalents thereof.

What is claimed is:

1. A unique Web search engine to help people find information on the Web more easily and efficiently, said Web search engine comprising:
(a) a simple hierarchical structure under the category Web;
(b) multiple ranks of records;
(c) diversified views of search results;
(d) display of unlimited records that are matched with keywords in the database; and
(e) opening any page of search results randomly.

2. The Web search engine according to claim 1, wherein the simple hierarchical structure comprising:
(a) top node: Web;
(b) the sub nodes of Web: Resource, Product and Service;
(c) the sub nodes of Resource: General and Music;
(d) the sub nodes of Product: Large Business and Small Business;
(e) the sub nodes of Service: Anywhere and Local;
(f) the property of Resource: Download;
(g) the property of Product: Shopping;
(h) the property of Service: Reservation; and
(i) the property of Local: Location.

3. The Web search engine according to claim 1, wherein the multiple ranks of records comprising:
(a) rank by statistics; and
(b) rank by human management.

4. The Web search engine according to claim 1, wherein the diversified views of search results comprising:
(a) sorting by the title of Web pages;
(b) sorting by domain name; and
(c) sorting by date.

5. The Web search engine according to claim 1, wherein all search results can be displayed no matter how large the database is and how many records are matched with keywords in the database.

6. The Web search engine according to claim 1, wherein any page can be randomly opened by inputting a page number.

7. A page-sized query algorithm which is applicable to Web search engines and other systems using large-scale databases, said page-sized queries only return a small set of records which number is equal to or a little larger than the record number for one page, and the records are directly displayed from the beginning of the record set on all pages.

8. The page-sized query algorithm according to claim 7, wherein the major issue of said algorithm is to determine a value X based on which the records are retrieved from the database. If expressed with Structure Query Language (SQL), it is an additional value in WHERE clause with the operator “>”, “>=”, “<”, “<=”, “LIKE” or “BETWEEN . . . AND . . . ” besides the actual query criteria The determination of the value X comprising:
(a) initial page: it is larger than or equal to the minimum value in ascending order, and less than or equal to the maximum value in descending order;
(b) next page: it is larger than the value of the last record on the current page in ascending order; and less than the value of the last record on the current page in descending order; and
(c) previous page: it is less than the value of the first record on the current page in ascending order, and larger than the value of the first record on the current page in descending order.
